(19) United States
(12) Patent Application Publication
(10) Pub. No.: US 2004/0166825 A1
(43) Pub. Date: Aug. 26, 2004

(54) Wireless receiver

(76) Inventors: Jen-Sheng Huang, Hsinchu (TW); Yeong-Luh Ueng, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/372,189

(22) Filed: Feb. 25, 2003

(51) Int. Cl. H04B 1/26; H04B 15/00

(52) U.S. Cl. 455/313; 455/323

(57) ABSTRACT

The present invention provides a wireless receiver with the multi-channel or the single-channel. The present invention is utilizing a pre-selector to pre-choose the signal within the category of the frequency band. Then, according to the different channel code to choose the corresponding local oscillation frequency, the present invention utilizes a frequency down converter referring to the local oscillation frequency to sequentially performing the frequency down step and the filtering step to obtain a low frequency signal. Then, a low pass filter is used to perform the filtering step of the low frequency signal, a limiter is used to amplify the signal, and a frequency discriminator is used to demodulate the signal so as to obtain a base-band signal. The present invention can simplify the complexity of the apparatus and quickly change the channel to achieve the effect of multi-channel receiving to achieve the purpose of the application of receiving the signal of the multi-channel and the single channel. The present invention can also provide with the advantage of the high ability of the anti-interference.

### BACKGROUND OF THE INVENTION

1. Field of the Invention

The present invention generally relates to a wireless communication technology, and more particularly relates to a wireless communication receiver with the multi-channel or the single-channel, which can apply to the application of the wireless products.

2. Description of the Prior Art

Recently, with the more improvement of the semiconductor manufacturing processes, the rising of the information appliances and the use of the wireless communication, the digital broadcasting, the broadband network are adequately proved the coming of the century of the IT life as well as the information transmission becomes more promptly and more diversely. In order to match the increasing requirement of the information, the personal wireless communication technology is become the attention-getting star in the recent years and the requirement of the wireless products is respectively enhanced.

In the wireless communication products, the main devices usually comprise the receiver and the transmitter. The present invention relates to an innovation of the receiver. Referring to the structure of the prior receiver 10 in the FIG. 1, a pre-selector 12 utilizes to choose the radio frequency signal within the category of the frequency channel as receiving a radio frequency signal and then the radio frequency signal sends to a mixer 14. At this time, a phase-locked loop (PLL) based frequency synthesizer 16 is generating a stable reference frequency into the mixer 14 so as the mixer 14 according to the reference frequency to mix with the radio frequency signal to generate a frequency down signal. Then, after sequentially passing the frequency filtering of the band-pass filter 18, the amplifying of the limiter 20, and the demodulating of the frequency discriminator 22, a base-band signal is obtained lastly.

Owing to the prior art needs to utilize the phase-locked loop (PLL) based frequency synthesizer 16 to choose and switch the receiving frequency so as to perform the receiving of multi-channels. However, the band-pass filter 18 in the mentioned receiver needs to include a high pass filter and a low pass filter. On the other hand, the phase-locked loop (PLL) based frequency synthesizer 16 can be implemented by using either a discrete IC or embedding the frequency synthesizer 16 in the same chip of the receiver. Using a discrete IC for the frequency synthesizer causes the problem of too large size. If the frequency synthesizer is directly formed on the single chip with other devices of the receiver, the manufacturing technology is too difficult and it causes the increasing of the cost and still has the problem of too large size if comparing with the present invention. The prior art cannot match the requirement of the trend of light, thin, short, and small. Besides, the prior receiver 10 must utilize the action of the frequency synthesizer 16 and the mixer 14 to perform the receiving the multi-channels, so it limits the channel-switching speed and provides with the problem of too much phase noise.

Hence, the main spirit of the invention is to provide a multi-channel wireless communication receiver, and then some disadvantages of well-known technology are overcome.

### SUMMARY OF THE INVENTION

The primary object of the present invention is to provide a wireless receiver with the multi-channel or the single-channel, which can simplify the complexity of the apparatus and merely utilizes the function of a frequency down converter and a low pass filter so as to quickly changing the channel to achieve the effect of multi-channel receiving.

Another object of the present invention is to provide a wireless receiver with the multi-channel or the single-channel, which can effectively reduce the interference of the phase noise so as can provide with the advantage of high ability of the anti-interference.

A further object of the present invention is to provide a low cost wireless receiver and a quickly and accurately frequency down method so as to apply to the application of receiving the signal of the multi-channel and the single channel.

A furthermore object of the present invention is to provide a wireless receiver with simple structure, which utilizes the common manufacturing technology to directly to form each device on single chip to match the compact trend of the wireless products.

In order to achieve previous objects, the present invention can receive the transmitted signal and perform the processing of the signal. The wireless receiver comprises a frequency down converter, wherein the frequency down converter chooses a corresponding local oscillation frequency in accordance with different channel codes and then referring to the local oscillation frequency to perform a frequency down and filtering step of the signal to obtain a low frequency signal. Then, the low frequency signal passes a low pass filter to perform the filtering step so as to let the signal within frequency band pass. Last, a limiter and a frequency discriminator utilize to perform the amplifying step and the demodulation step so as to output a base-band signal.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a schematic representation of the architecture of the receiver, in accordance with the prior technology;

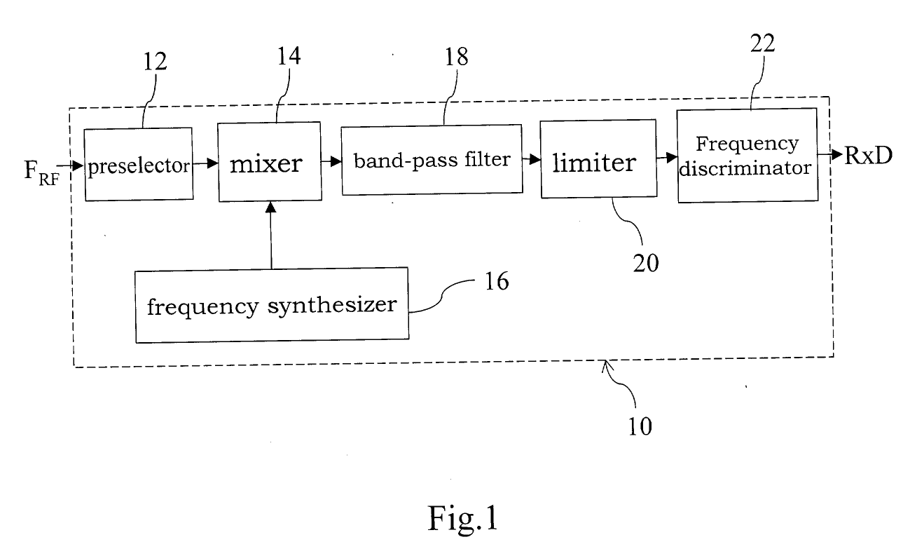

FIG. 2 is a schematic representation of the architecture in accordance with the present invention;

FIG. 3 is a schematic representation of the architecture of the frequency down converter, in accordance with one embodiment of the present invention; and

FIG. 4 is a schematic representation of the architecture of the frequency down converter, in accordance another embodiment of with the present invention.

### DESCRIPTION OF THE PREFERRED EMBODIMENT

The present invention utilizes a frequency down converter to respectively perform the frequency down step of the different receiving frequency and to match the use of the low pass filter (LPF) so as the present apparatus can perform the receiving of the multi-channel and or the single channel. The following description utilizes the receiving of the multi-channel to explain the technology content of this invention.

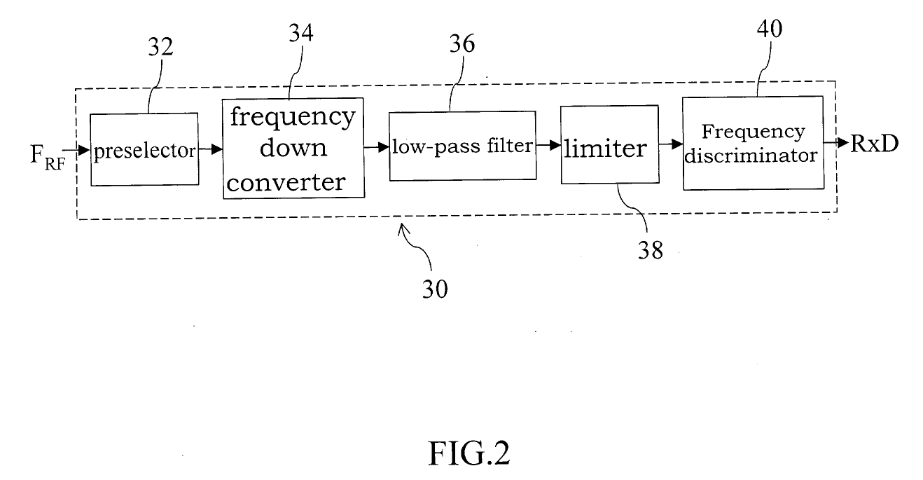

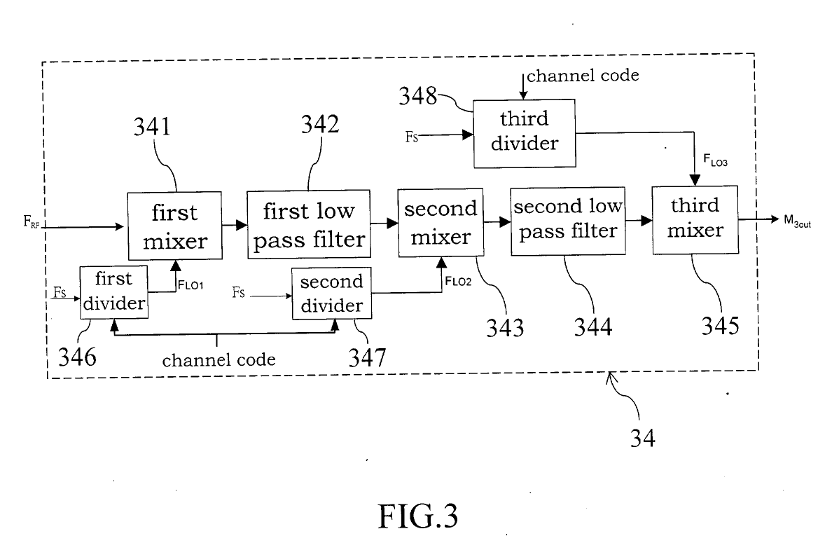

Referring to the FIG. 2, it is a schematic representation of the architecture in accordance with the present invention. The multi-channel wireless receiver 30 can simultaneously receive the radio frequency (RF) signal with different receiving frequency. Using the RF signal as the preferred embodiment of the present invention, the present invention can also receive other signals, such as the intermediate frequency after frequency down, to perform the processing of the signal. When the receiver 30 is receiving a radio frequency signal, a pre-selector 32 is utilized to choose a radio frequency signal within the category of the frequency band and then the processed radio frequency signal is transferred to a frequency down converter 34. Owing to the different receiving frequency of the radio frequency signal is respectively provided with a channel code, so the frequency down converter 34 can choose the corresponding local oscillation frequency in accordance with the channel code and then refer to the local oscillation frequency to perform a frequency down and filtering step of the radio frequency signal, which is chosen by the pre-selector 32, to obtain a low frequency signal. Then, a low pass filter 36 is utilized to filter the signal so as to let the signal within frequency band pass and to stop other signals pass. Besides, there is another limiter 38 connecting to the low pass filter 36 to amplify the signal passed the low pass filter 36. Last, a frequency discriminator 40 using as a demodulator to demodulate the signal inputted by the limiter 38 so as to let the frequency discriminator 40 to send a base-band signal.

Wherein the frequency down converter 34 mentioned above is as shown in the FIG. 3. Under the consideration with the current technology and the cost, the frequency down converter 34 is composed of three mixers and two low pass filters, such as the shown in the drawing. When the radio frequency signal processed by the pre-selector 32 is transferring to the first mixer 341, the first divider 346, which is according to the system clock F_{S} and the channel code, generates a first local oscillation frequency F_{LO1}. Referring to the first local oscillation frequency F_{LO1} as a reference frequency, the radio frequency signal is performed the fist frequency down step and the signal is transferred to the first low pass filter 342 to perform the first filtering step to filter the unwanted signal. Then, the signal is transferred to the second mixer 343 and a second divider 347, which is according to the system clock F_{S} and the channel code, generates a second local oscillation frequency F_{LO2}. Referring to the second local oscillation frequency F_{LO2} as a reference frequency, the radio frequency signal is performed the second frequency down step and the signal is transferred to the second low pass filter 344 to perform the second filtering step to filter the unwanted signal. Last, the signal is transferred to the third mixer 345. At this time, the third divider 348, which is according to the system clock F_{S} and the channel code, generates a third local oscillation frequency F_{LO3}. Referring to the third local oscillation frequency F_{LO3} as a reference frequency, the radio frequency signal is performed the third frequency down step. Hence, the sequential frequency down steps can sequentially down the receiving radio frequency (RF) signal into the demodulate-able signal.

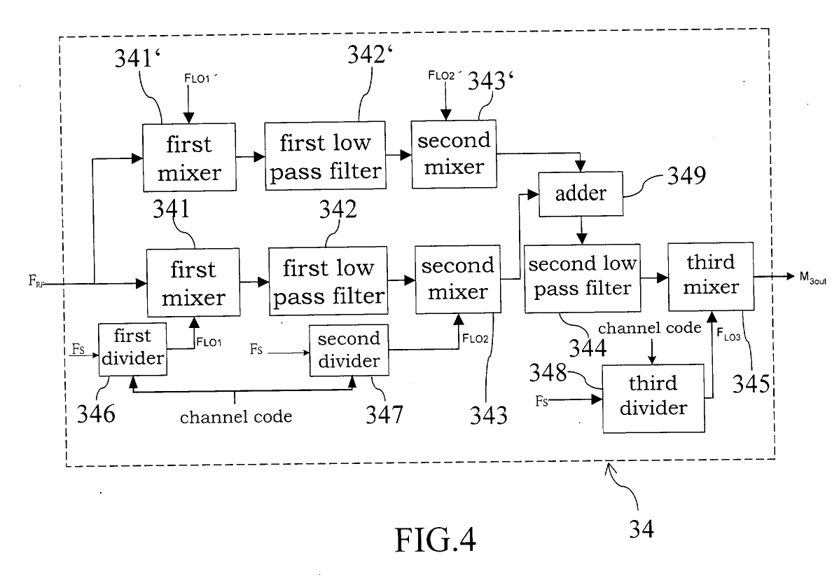

Besides, the radio frequency signal is divided into the I (In-phase) path and the Q (Quadrature-phase) path, simultaneously referring to the FIG. 4. The I (In-phase) path of the radio frequency signal within the frequency down converter 34 will be performed a first frequency down step of the first mixer 341, a signal filtering step of the low pass filter 342, and a second frequency down step of the second mixer 343. At the same time, the Q (Quadrature-phase) path of the radio frequency signal within the frequency down converter 34 will be performed a first frequency down step of the first mixer 341′, a signal filtering step of the low pass filter 342′, and a second frequency down step of the second mixer 343′. Then, an adder 349 is utilized to synthesize the processed I path signal and the Q path signal into a signal. Then, after the filtering step of the second low pass filter 344 and the third frequency down step of the third mixer 345, the radio frequency signal is transferred into the demodulate-able signal. Other technology theorem is the same as the embodiment of the FIG. 3 and not redundantly described herein. Actually, the embodiment of the FIG. 4 is to replace the first mixer 341, the low pass filter 342, and the second mixer 343 of the embodiment of the FIG. 3 into the architecture of the image rejection mixer.

Besides the embodiment mentioned above, the present invention could further arrange or replace other apparatus or device with the same function between the mixer or the low pass filter mentioned above to achieve the same effect. On the other words, the present invention is to cover the frequency down of the signal by utilizing the frequency down converter. Besides, the low pass filter mentioned above can also be other device and apparatus with the filtering function and the frequency discriminator also can be a demodulator.

From the receiving of the radio frequency signal, owing to the receiving frequency of different channel respectively have a channel code to let the frequency down converter 34 according to the channel code to choose a corresponding local oscillation frequency for using as a reference frequency to achieve the multi-channel receiving. Hence, the present invention is utilizing three of the frequency down steps of the mixer and the two filtering steps of the low pass filter to sequentially reduce the frequency to a demodulate-able low frequency signal. Besides, the present invention utilizes the theorem and the method mentioned above can also apply to the receiver of the single channel to achieve the receiving of the signal channel.

Hence, the present invention utilizes the frequency down converter composed of a simple structure and low cost mixer and the low pass filter and according to the local oscillation frequency to replace the complicated and expensive PLL frequency synthesizer and the mixer to simplify the complexity of the apparatus and to match the trend of light, thin, short, and small. The present invention does not need the use of the PLL frequency synthesizer and can quickly change the channel to achieve the effect of multi-channel receiving to achieve the purpose of the application of receiving the signal of the multi-channel and the single channel. Besides, the present invention is disclosed a wireless receiver with the multi-channel or the single-channel and its quickly and accurately frequency down method. The present invention can reduce the interference of the phase noise so as to provide with the advantage of the high ability of the anti-interference.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A wireless receiver which can receive the transmitted signal to perform processing said signal, said wireless receiver comprising:
a frequency down converter, wherein said frequency down converter chooses a corresponding local oscillation frequency in accordance with different channel codes and then referring to said local oscillation frequency to perform a frequency down and filtering step of said signal to obtain a low frequency signal;
a filter, wherein said filter is to perform a filtering step of said low frequency signal so as to let the signal within frequency band pass;
a limiter, wherein said limiter is connecting to said low pass filter to amplify the signal passed said filter; and
a frequency discriminator, wherein said frequency discriminator is to perform a demodulation step of the signal received from said limiter so as to produce a base-band signal.

2. The wireless receiver according to claim 1, wherein said frequency down converter comprises:
at least a mixer to perform a frequency down step of said signal after referring to a local oscillation frequency; and
at least a filter to perform a filtering step of said frequency down signal so as to obtain a demodulate-able signal.

3. The wireless receiver according to claim 2, wherein said mixer is in accordance with different channel codes to choose said corresponding local oscillation frequency to provide said mixer for frequency down.

4. The wireless receiver according to claim 1, wherein after said transmitted signal into said frequency down converter, said signal is divided into multi-way signals and said signals in said frequency down converter is respectively utilizing at least a mixer and a filter to perform a frequency down and filtering step of said signal and then to synthesize said multi-way signals pass an adder to obtain a low frequency signal.

5. The wireless receiver according to claim 1, wherein said filter is a low-pass filter or other equipments with filtering function.

6. The wireless receiver according to claim 2, wherein said filter is a low-pass filter or other equipments with filtering function.

7. The wireless receiver according to claim 4, wherein said filter is a low-pass filter or other equipments with filtering function.

8. The wireless receiver according to claim 1, wherein said frequency down converter further connects a pre-selector so as to transmit said signal to said frequency down converter after said signal within frequency band.

9. The wireless receiver according to claim 1, wherein said signal can be selected from the group of a multi-channel radio frequency signal, single channel radio frequency signal, or a intermediate frequency signal after frequency down.

10. The wireless receiver according to claim 1, wherein said frequency discriminator is a demodulator.

11. The wireless receiver according to claim 1, wherein the receiving frequency of multi-channel of said signal is respectively provided with a channel code so as said frequency down converter can chooses a corresponding local oscillation frequency in accordance with said channel code as reference for frequency down.

12. The wireless receiver according to claim 1, wherein said local oscillation frequency is obtained by utilizing a frequency divider in accordance with a system clock and said channel code.
